(19) United States
(12) Patent Application Publication
(10) Pub. No.: US 2013/0042516 A1
(43) Pub. Date: Feb. 21, 2013

(54) SYSTEM AND METHOD FOR ELECTROFISHING

(71) Applicant: Thomas Franklin Lehman, Lee's Summit, MO (US)

(72) Inventor: Thomas Franklin Lehman, Lee's Summit, MO (US)

(73) Assignee: MIDWEST LAKE MANAGEMENT, INC., Polo, MO (US)

(21) Appl. No.: 13/586,431

(22) Filed: Aug. 15, 2012

Related U.S. Application Data
(60) Provisional application No. 61/524,642, filed on Aug. 17, 2011.

(51) Int. Cl. A01K 79/02; A01K 79/00

(52) U.S. Cl. 43/4.5; 43/17.1

(57) ABSTRACT

An electrofishing controller includes a power input, an output and a user interface for receiving configuration information from a user. The controller further includes control circuitry for receiving electric power from the power input, generating an electric waveform with characteristics defined by the configuration information, and communicating the electric waveform to the output. The control circuitry is configured to automatically adjust the electric waveform in response to changes in an electric load on the output, and to automatically restore the electric waveform when the electric load returns to a normal operating level. The control circuitry is further configured to automatically reconfigure a power circuit in response to changes in the configuration information received from the user, including changing physical connections between physical components of the power circuit.

### RELATED APPLICATIONS

This non-provisional patent application claims priority benefit with regard to all common subject matter of earlier-filed U.S. Provisional Patent Application No. 61/524,642, filed Aug. 17, 2011, and entitled SYSTEM AND METHOD FOR ELECTROFISHING. The earlier-filed provisional application is hereby incorporated by reference in its entirety into the present application.

### BACKGROUND

1. Field

Embodiments of the present invention relate to systems and methods for electrofishing. More particularly, embodiments of the present invention relate to electrofishing systems with user configurable output waveforms.

2. Related Art

Electrofishing is a method of controlling, immobilizing or capturing fish and involves energizing a body of water with an electric current to temporarily stun fish in the water. Electrofishing is commonly used for research and monitoring purposes. By way of example, electrofishing is used to perform surveys or population estimates to determine the type and number of fish present in a body of water or to capture and transfer fish from one body of water or locality to another. Electrofishing may also be used to guide the movement of fish, such as to keep predators away from a freshly planted stock of young fish and to keep fish away from electric power plant water intakes.

Electrofishing systems typically include a source of electric power, such as a battery or an electric generator, connected to a cathode and an anode that are placed in contact with the water in which the targeted fish are present or anticipated to be present. When an electric voltage of sufficient magnitude is applied to the anode and the cathode, an electric current passes between the anode and the cathode through the water. Any fish that are in sufficiently close proximity to the cathode and anode are rendered immobile or otherwise physically impaired by the electric current.

Electrofishing is typically performed in open, unstable environments with changing electrical characteristics, such as lakes and rivers, and is often performed while travelling through the water on a boat. In these environments, the electrical properties of the water, such as electrical conductivity, are often unpredictable and may change during an electrofishing operation due to movement of the water and objects in the water and movement of the electrofishing system through the water. Accordingly, there is a need for an electrofishing system adapted to operate in environments with unknown and dynamic electrical properties.

### SUMMARY

Embodiments of the present invention solve the above-described problems by providing an automated electrofishing controller operable to detect changes in the electric load on the system and adjust operation of the controller to avoid overloading the electrofishing system.

An electrofishing controller in accordance with an embodiment of the invention comprises a power input, an output and a user interface for receiving configuration information from a user. The controller further includes control circuitry for receiving electric power from the power input, generating an electric waveform with characteristics defined by the configuration information, and communicating the electric waveform to the output. The control circuitry is configured to automatically change the characteristics of the electric waveform in response to changes in an electric load on the output, and to automatically restore the electric waveform to the characteristics defined by the configuration information.

An electrofishing controller in accordance with another embodiment of the invention comprises a power input, an output, a user interface, and control circuitry. The controller receives first configuration information from a user via the user interface, the first configuration information including pulse frequency, duty cycle, and voltage level. The control circuitry receives electric power from the power input, generates an electric waveform with characteristics defined by the first configuration information, and communicates the electric waveform to the output.

The control circuitry is configured to automatically decrease the voltage level of the electric waveform in response to an increased current drawn from the output and to automatically restore the voltage level of the electric waveform to the voltage level received from the user when the current decreases. The control circuitry is further configured to change the characteristics of the electric waveform in response to receiving second configuration information from the user by changing physical connections between circuit components, such that a first circuit generates a first electric waveform according to the first configuration information and a second circuit generates a second electric waveform according to the second configuration information.

A method of generating an electric waveform for electrofishing in accordance with yet another embodiment of the invention comprises receiving electric power, receiving configuration information from a user, generating the electric waveform using the electric power and according to the configuration information received from the user, and communicating the electric waveform to an electrofishing circuit. The characteristics of the electric waveform are automatically changed in response to changes in an electric load, and are automatically restored to characteristics defined by the configuration information received from the user.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWINGS

FIG. 1 is a diagram of an electrofishing system constructed in accordance with embodiments of the invention and broadly including a power source, a controller and an electrofishing circuit;

FIG. 2 is a diagram illustrating various elements of the controller of the electrofishing system of FIG. 1;

FIG. 3 is a front perspective view of a housing of the controller of FIG. 1 illustrating a user interface including a control panel, an emergency stop button and a breaker switch;

FIG. 4 is an enlarged illustration of the control panel of FIG. 3;

FIG. 5 is a rear elevation view of the controller of FIG. 1 illustrating a plurality of fuse cases, a capped power input connector, a capped output connector and a capped switch input connector;

FIG. 6 is a rear elevation view of the controller of FIG. 5, illustrating the power input connector, the output connector and the switch input connector with protective caps removed;

FIG. 7 is an electrical circuit schematic diagram of various electrical components of control circuitry of the controller of FIG. 1, the schematic diagram illustrating a power circuit portion of the control circuitry;

FIG. 8 is a chart illustrating three exemplary voltage ranges in which the controller of FIG. 1 may operate when in a direct current mode and exemplary maximum current ratings corresponding to each voltage range;

FIG. 9 is a table listing the voltage ranges of FIG. 8 and the corresponding maximum current rating each voltage range broken down according to duty cycle;

FIG. 10 is a chart illustrating an exemplary range of voltages in which the controller of FIG. 1 may operate when in an alternating current mode and an exemplary maximum current rating across the range of voltages;

FIG. 11 is a graph of an output waveform generated by the controller of FIG. 1 operating in alternating current mode and configured to generate a first full-cycle output waveform;

FIG. 12 is a graph of an output waveform generated by the controller of FIG. 1 operating in alternating current mode configured to generate a second full-cycle output waveform;

FIG. 13 is a graph of an output waveform generated by the controller of FIG. 1 operating in alternating current configured to generate a third full-cycle output waveform;

FIG. 14 is a graph illustrating an exemplary output waveform generated by the controller of FIG. 1 operating in alternating current mode and configured to generate a first positive one-half cycle output waveform;

FIG. 15 is a graph illustrating an exemplary output waveform generated by the controller of FIG. 1 operating in alternating current mode and configured to generate a second positive one-half cycle output waveform;

FIG. 16 is a table listing the settings of the controller corresponding to various positive one-half cycle output waveforms;

FIG. 17 is a graph illustrating an exemplary output waveform generated by the controller of FIG. 1 operating in alternating current mode and configured to generate a first single cycle output waveform;

FIG. 18 is a graph illustrating an exemplary output waveform generated by the controller of FIG. 1 operating in alternating current mode and configured to generate a second single cycle output waveform;

FIG. 19 is a table listing the settings of the controller corresponding to various single cycle output waveforms;

FIG. 20 is a graph illustrating an exemplary output waveform generated by the controller of FIG. 1 operating in alternating current mode and configured to generate a first one and one-half cycle output waveform;

FIG. 21 is a graph illustrating an exemplary output waveform generated by the controller of FIG. 1 operating in alternating current mode and configured to generate a second one and one-half cycle output waveform;

FIG. 22 is a table listing the settings of the controller corresponding to various one and one-half cycle output waveforms;

FIG. 23 is a graph illustrating an exemplary output waveform generated by the controller of FIG. 1 operating in alternating current mode and configured to generate an alternate polarity output waveform;

FIG. 24 is a table listing the settings of the controller corresponding to various alternate polarity output waveforms;

FIG. 25 is a graph illustrating an exemplary output waveform generated by the controller of FIG. 1 operating in alternating current mode and configured to generate an alternating single cycle output waveform;

FIG. 26 is a table listing the settings of the controller corresponding to various alternating single cycle output waveforms; AND

FIG. 27 is a graph illustrating an exemplary output waveform generated by the controller of FIG. 1 operating in the direct current mode.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention may be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

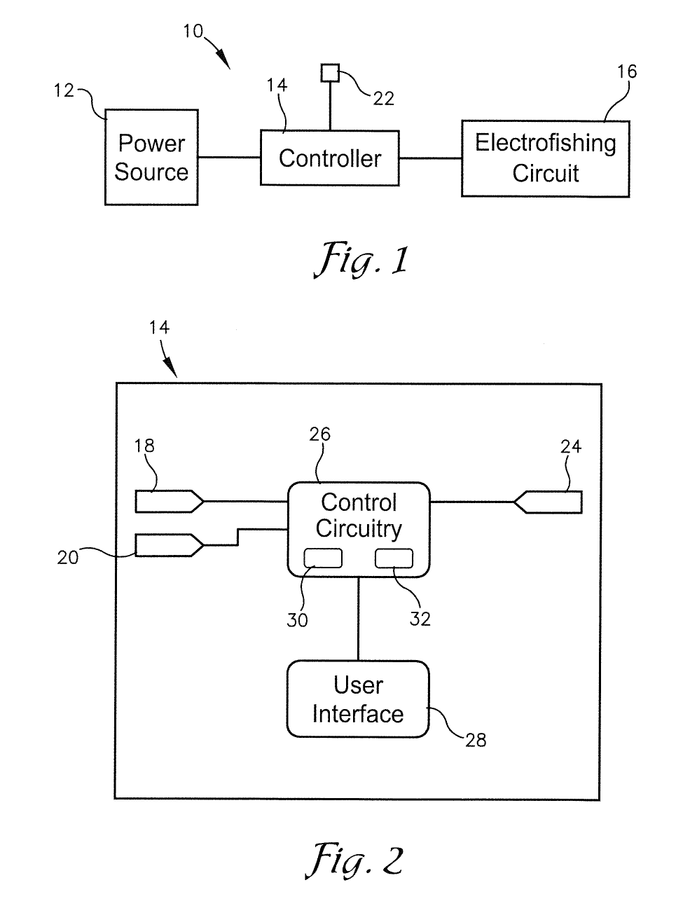

Referring now to the drawings, wherein like reference numerals designate identical or corresponding parts throughout the several views, an electrofishing system 10 constructed in accordance with embodiments of the invention is illustrated. With particular reference to FIGS. 1-6, the electrofishing system 10 broadly includes a power source 12, a controller 14 and an electrofishing circuit 16. The power source 12 generates electric power and delivers the electric power to the controller 14 for energizing the controller 14 and the electrofishing circuit 16. The power source 12 may be an electric generator, such as an internal combustion electric generator. In the exemplary embodiment illustrated in the drawings and discussed in detail herein, the power source 12 is a 240 volt, 60 Hz alternating current generator with an isolated case neutral that may generate between 2500 watts and 9500 watts of electric power. It will be appreciated by those skilled in the art that other types of power sources may be used without departing from the spirit or scope of the invention.

The electrofishing circuit 16 receives an electric waveform from the controller 14 and applies the electric waveform to the water in which the electrofishing circuit 16 is operating to energize the water with an electric current. The electrofishing circuit 16 includes a cathode and an anode. By way of example, if the system 10 is mounted on a boat (not illustrated), the boat hull may serve as the cathode while the anode or anodes may comprise metal dropper arrays mounted on one or more insulated booms extending a distance from the boat hull and positioned such that the metal dropper arrays contact the water. Metal dropper arrays may include a plurality of metal tubes suspended from the insulated booms by flexible cable. In one exemplary embodiment the anode comprises two metal dropper arrays, wherein each dropper array is mounted on an insulated boom approximately seven feet in length. The booms may be positioned such that the dropper arrays contact the water on opposite sides of a boat on which the system 10 is carried.

The controller 14 receives power generated by the power source 12, receives configuration information from a user, generates the output electric waveform according to the configuration information received from the user, and communicates the output electric waveform to the electrofishing circuit 16. The controller 14 broadly includes a power input 18 for receiving power from the power source 12, a switch input 20 for receiving input from an external activation switch 22, an output 24 for communicating the output electric waveform to the electrofishing circuit 16, control circuitry 26, and a user interface 28 for receiving the configuration information from the user and for communicating system information to the user. The control circuitry 26 includes, without limitation, a power circuit 30 and control software 32.

As used herein, an “electric waveform” includes continuous electrical activity, such as a continuous sinusoidal waveform and discontinuous activity, such as a series of electric pulses.

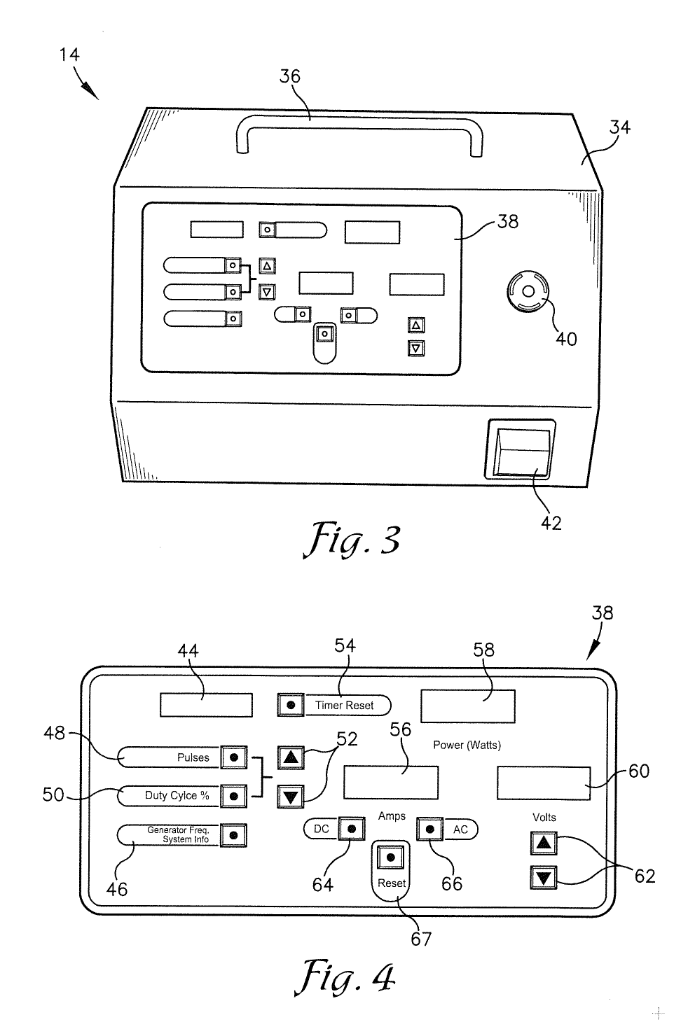

With particular reference to FIGS. 3 and 4, a front portion of a housing 34 of the controller 14 is illustrated including various user interface elements, including a handle 36, a control panel 38, an emergency stop button 40 and a main power breaker switch 42 encased in a water-tight protective cover. The emergency stop button 40 is easily accessible and prominently displayed and includes a light emitting diode or similar light source for illuminating the button 40. The emergency stop button 40 may be illuminated, for example, when the system 10 is operating and the external switch 22 is active to indicate to the user that the system 10 is live. Furthermore, the emergency stop button 40 may be configured such that it must be rotated at least partially to release after being depressed. This feature ensures that the system 10 remains off after an emergency stop until the user deliberately reactivates the system 10.

The control panel 38 includes a system information display 44 that alternately displays fishing time, power source information including voltage and frequency, controller cumulative hour meter, a dimmer level associated with the emergency stop button 40 light source, display and power board revisions, and output electric waveform information including pulses and duty cycle. The fishing time indicates the cumulative amount of fishing time since the timer was last reset. In other words, the fishing time indicates the cumulative amount of time an output electric waveform was communicated to the electrofishing circuit 16 since the reset button was last engaged to reset the timer. The power source voltage value displayed on the display 44 is the root-mean-square (RMS) value of the input voltage waveform. The controller cumulative hour meter is a running total of the time the controller 14 has been powered up over the life of the controller 14. The pulses indicate the number of pulses per second the controller 14 is currently set to generate, and the duty cycle is a duty cycle percentage of the output electric waveform. The duty cycle value displayed on the display 44 has a slightly different meaning depending on whether the controller 14 is operating in AC mode or DC mode, as explained below.

Selecting the system information button 46 causes the system information display 44 to cycle through the information listed above, except for the pulse information and the duty cycle information, which have dedicated buttons. Selecting the pulses button 48 causes the current pulse rate to display on the system information display 44 and selecting the duty cycle button 50 causes the current duty cycle to appear on the display 44. When the pulse rate is displayed in the system information display 44, the user can increase or decrease the pulse rate using the adjust buttons 52. Similarly, when the duty cycle value is displayed in the system information display 44, the user can increase or decrease the duty cycle using the same adjust buttons 52. Increasing or decreasing the pulse rate or duty cycle in this manner causes the controller 14 to adjust the output electric waveform communicated to the electrofishing circuit 16 accordingly. The controller 14 may make the adjustment during operation of the controller 14, such that the output electric waveform is adjusted even while the controller 14 is communicating the waveform to the electrofishing circuit 16.

A timer reset button 54 resets the fishing time, or the cumulative amount of time the electrofishing circuit 16 has been activated since the last time the reset button 54 was selected, as explained above. The amps display 56 indicates a current magnitude of the electric current delivered by the controller 14 via the output 24 in amperes and will vary depending on the controller 14 settings and the electric load on the output 24. A power display 58 indicates a current level of power delivered by the controller 14 in watts and will also vary depending on controller 14 settings and the electric load on the output 24. A voltage display 60 indicates a current magnitude of the voltage delivered by the controller 14 in volts. While the user selects the target output voltage level using voltage level adjust buttons 62, the actual output voltage may fluctuate if the electric load changes. In extreme situations, such as where increased conductivity of the operating environment causes a current overload on the controller 14, the control circuitry 26 automatically adjusts the output voltage downward to eliminate the overload and protect the controller 14 circuitry. The value displayed on the voltage display 60 is the root-mean-square (RMS) value of the output electric 30 waveform communicated to the electrofishing circuit if the controller 14 is operating in AC mode, and is the amplitude of the waveform pulses if the controller 14 is operating in DC mode. A DC button 64 enables the user to set the controller 14 to operate in direct current mode, and an AC button 66 enables the user to set the controller 14 to operate in alternating current mode.

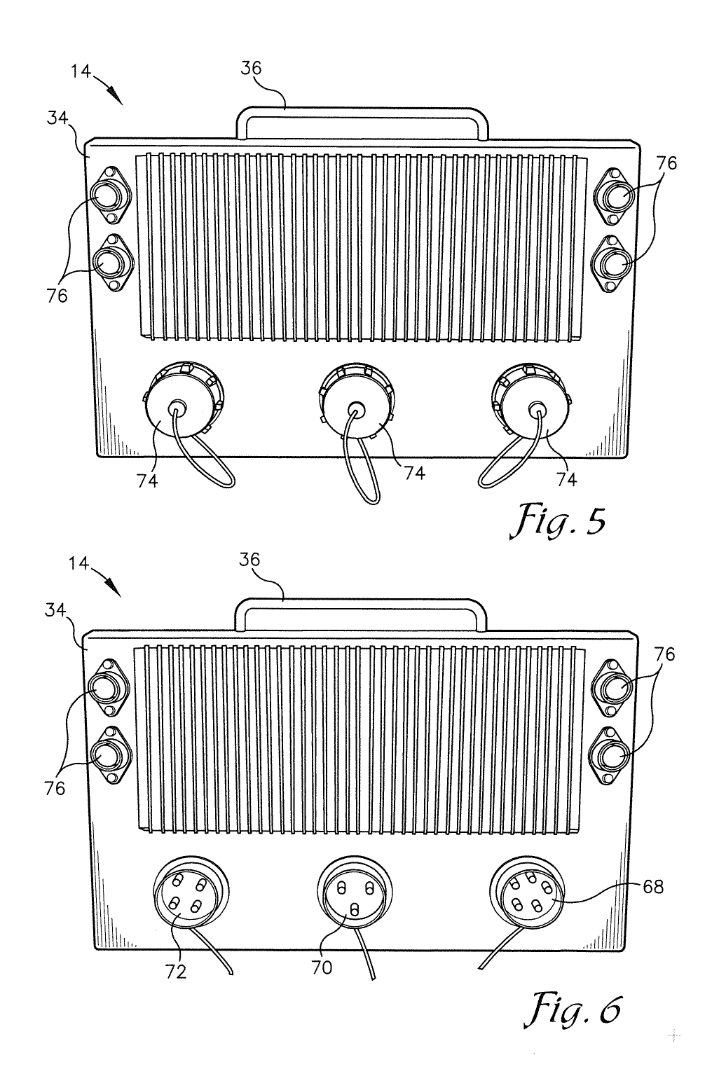

A rear portion of the controller housing 34 is illustrated in FIGS. 5 and 6, and includes a plurality of input/output connectors and a plurality of fuses. The connectors include a power input connector 68 for connecting to the power source 12, a switch connector 70 for connecting to the external switch 22, and an output connector 72 for connecting the controller to the electrofishing circuit 16. Each of the connectors 68, 70, 72 preferably includes a protective cover 74 tethered to the housing 34, may be UV resistant, rated to operate at thirty-two amps, and may be sealed with O-rings or gaskets to prevent moisture or dust from entering the housing 34. Each of the connectors 68, 70, 72 also preferably has a positive locking keyway that terminates in a unique receptacle to prevent accidental connection errors. Each of the fuses 76 may be rated at 25 amps and mounted in a water-tight case. Three of the fuses 76 may be operational while a fourth may be a spare.

Referring again to FIG. 2, the control circuitry 26 includes a power circuit 30 and control software 32. The control software 32 includes computer readable instructions for managing operation of the control circuitry 26, including the power circuit 30, according to the configuration and mode information received from the user via the user interface 28. The control circuitry 26 includes one or more computer processors for executing the control software 32, and the control software 32 may be stored in a memory device accessible by the one or more computer processors. When reference is made herein to the control software 32 performing an operation or a function, it will be understood that the control software 32 is executed by the one or more computer processors that perform the operation or function.

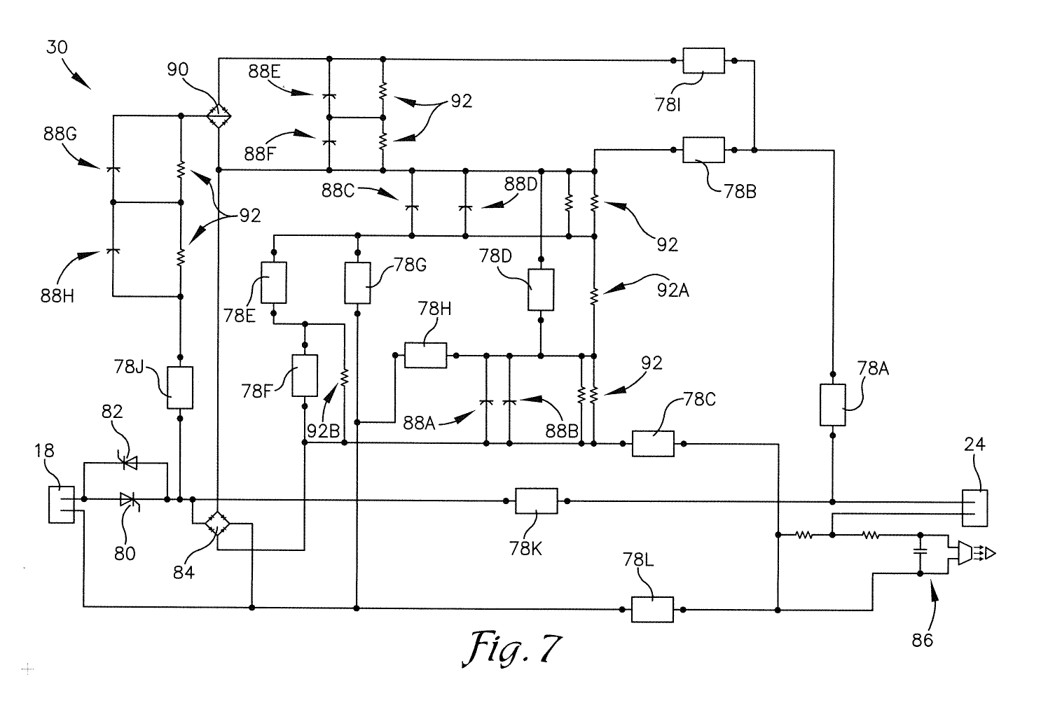

Details of the power circuit 30 are illustrated in FIG. 7. Broadly, the power circuit 30 receives power from the power source 12 via the power input 18 and communicates the output electric waveform to the electrofishing circuit 16 via the output 24. The power input 18 is connected to the input power connector 68 via breaker/on off switch 42. Output 24 is connected to output connector 72. The control software 32 operates a plurality of switches 78 to manage operation of the circuit 30 by directing current flow through various circuit components. The power circuit 30 further includes a pair of silicon-controlled rectifiers (SCRs) 80, 82, a rectifier bridge 84, a current detection circuit 86, a plurality of capacitors 88, a bridge circuit 90, and a plurality of resistors 92. Each of the capacitors 88 may have a capacitance of 3300 microfarads and the resistance of each of the resistors 92 is selected such that the resisters 92 discharge the capacitors 88 in a reasonable time. The switches 78 allow connecting capacitors 88D and 88D either in series or parallel with capacitors 88A and 88B. Resistor 92A keeps the positive side of 88C above the potential on the positive side of 88A during the switching time. Resistor 92B is used to quickly equalize the differences between the voltage across the capacitors when switching from mid voltage to low voltage.

The alternating current input power waveform flows from the input 18 to the SCRs 80, 82. The control software 32 controls the SCRs 80, 82 to shape the waveform received from the input 18, and the shaped waveform is communicated to the rest of the power circuit 30. Shaping the input power waveform regulates the electric power communicated to the power circuit 30 and, therefore, to the output 24. Shaping the waveform may also regulate the peak voltage communicated to the output 24 when the controller 14 is operating in AC mode. When the control circuitry 30 is operating in the AC mode, the waveform shaped by the SCRs 80, 82 is communicated directly to the output 24. When the control circuitry 30 is operating in DC mode, the waveform shaped by the SCRs 80, 82 is rectified and switched to generate a square wave that is communicated to the output 24.

The first SCR 80 passes positive portions of the input power waveform while the second SCR 82 passes negative portions of the input power waveform. The control software 32 phase shifts operation of the SCRs 80, 82 to selectively pass a portion of each cycle of the input power waveform—and therefore a portion of the input power—to the rest of the power circuit 30. In other words, the SCRs 80, 82 act as switches controlled by the software 32, and each may be activated at any point during each cycle of the input power waveform to pass all or a portion of each cycle. If the SCRs 80, 82 are always on, for example, the entire input power waveform is passed unimpeded. If each of the SCRs 80, 82 is turned on halfway through its respective cycle of the input power waveform, only one-half of the input power waveform is passed to the circuit 30. It will be appreciated that in this scenario, only one-half of the input power is passed to the circuit 30. Similarly, each of the SCRs 80, 82 may be activated to allow one-fourth or three-fourths of the input power waveform to be passed to the circuit 30, passing one-fourth or three-fourths of the input power, respectively, to the circuit 30. Virtually any portion of the input power waveform may be passed to the circuit 30 by selectively activating the SCRs 80, 82 at different times during the cycle of the input power waveform, as explained below in greater detail.

Each of the SCRs 80, 82 may be activated independently of the other, and the positive and negative portions of the input power waveform passed by the SCRs 80, 82 may be symmetrical or may be asymmetrical. By way of example, the first SCR 80 may be activated for all or a portion of each cycle of the input power waveform while the second SCR 82 is not activated at all. Similarly, the second SCR 82 may be activated for all or a portion of each cycle of the input power waveform while the first SCR 80 is not activated at all. Furthermore, the first SCR 80 may be activated for a first length of time and the second SCR 82 may be activated for a second length of time that is either longer than or shorter than the first length of time.

As mentioned above, the control software 32 manages operation of a plurality of switches 78 to connect and disconnect various components of the power circuit 30 thereby configuring the power circuit 30. More particularly, the switches 78 operated to switch the power section between AC and DC modes, and to switch between low voltage, middle voltage and high voltage DC configurations. The switches 78 may be relays, transistors or other electromechanical, electric or electronic switches. In one exemplary embodiment, all of the switches 78 are relays except for switch 78A, which is a transistor that gates the output in DC mode. The control software 32 turns the switch 78A on and off to create the output pulses when the controller 14 is operating in DC mode.

A bridge rectifier 84 provides full-wave rectification of the input power when the controller 14 is operated in DC mode. Input power rectification is necessary, for example, where the power source 12 is an AC generator producing a sinusoidal waveform. A current detection circuit 86 monitors the current flow through the output 24 and includes a pair of resistors, a capacitor and a current sensing integrated circuit, such as an integrated circuit from the HCPL-7510 isolated linear current sensing family of integrated circuits made by AVAGO TECHNOLOGIES. The control software 32 measures the output current using the current detection circuit 86 and measures the output voltage by detecting voltage across one or more of the capacitors 88. The measured output current level is displayed on the current display 56, and the measured current and voltage levels are used to determine the power level that is displayed on the power display 58.

The control software 32 may implement a soft start procedure to protect the power source 12, the power circuit 30 and other system components from spikes in electric energy. The soft start procedure includes gradually ramping up the output electric waveform from zero volts to the user-selected output voltage by gradually increasing the percentage of the input power waveform passed by the SCRs 80, 82 to the power circuit 30, thereby gradually increasing the input power applied to the circuit 30. If an overcurrent condition occurs during the soft start, the control software 32 stops increasing the voltage level and enters an overload mode, shifting the power circuit 30 to a lower voltage.

The user may change the operating mode of the controller 14 from AC to DC and vice versa during operation of the controller 14. When such a change is requested, the control software 32 temporarily disconnects the input power from the power circuit 30 by turning off both of the SCRs 80, 82, reconfigures the power circuit 30 as explained below, and connects the input power to the power circuit 30 using the soft start procedure described above.

When the controller 14 is operating in DC mode, the power circuit 30 is configured such that the SCRs 80, 82 charge at least some of the capacitors 88. The charged capacitors 88 are used to drive the output electric waveform. By activating each of the SCRs 80, 82 at different times during the cycle of the input power waveform, as explained above, the control software 32 regulates the degree to which the input power waveform charges the capacitors 88, which in turn determines the voltage magnitude of the output electric waveform. The control software 32 shapes the output electric waveform by turning on and off the switch 78A to generate a square wave sent to the output 24. By turning the switch 78A on and off, for example, the control software 32 determines when each pulse of the square wave begins, the duration of each pulse, and the overall duty cycle of the square wave.

An exemplary DC output waveform 94 is illustrated in FIG. 27. The waveform 94 is a substantially square wave with a voltage magnitude V approximately equal to the voltage set by the user via the voltage adjust buttons 62, a frequency equal to the frequency set by the user via the user interface 28, and a duty cycle (Ton/T) set by the user via the user interface 28.

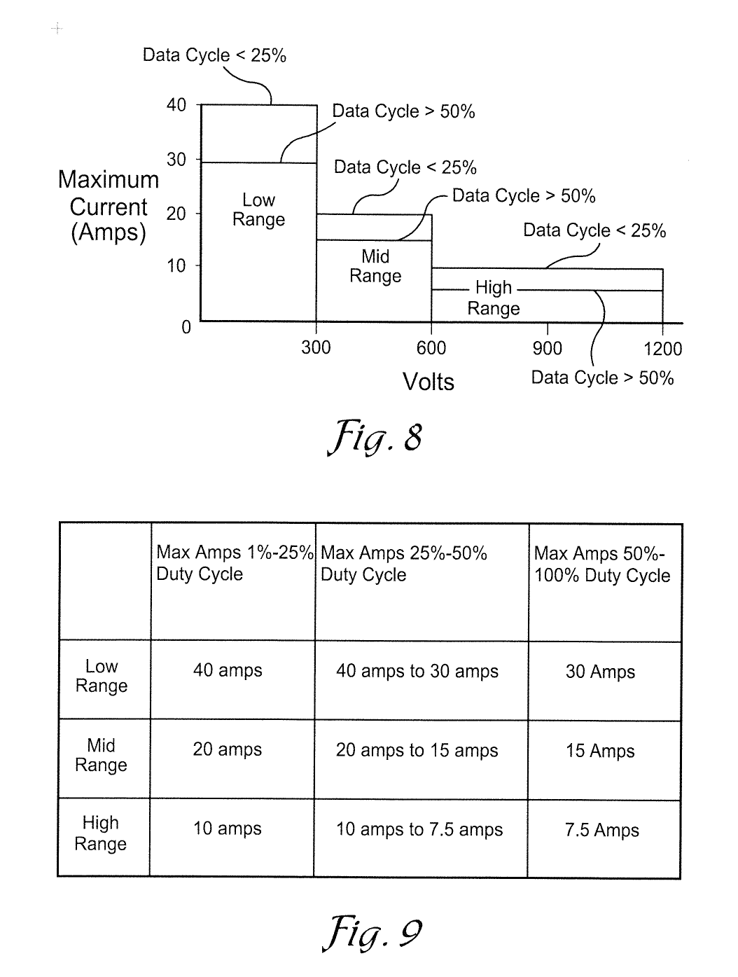

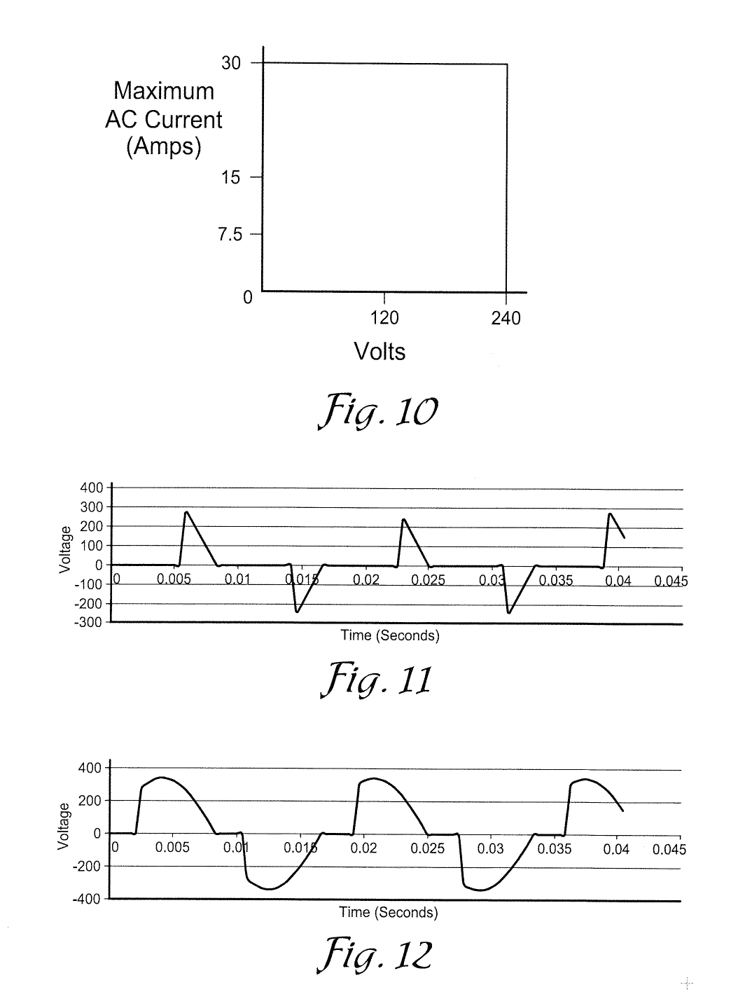

When operating in DC mode the controller 14 is in one of three voltage ranges, including low range, middle range and high range. As illustrated in FIGS. 8 and 9, the low voltage range is between 0 and about 300 volts with a maximum output current between 30 amps and 40 amps, depending on the duty cycle. The middle voltage range is between about 300 volts and about 600 volts with a maximum output current between 15 amps and 20 amps, depending on the duty cycle. The high voltage range is between about 600 volts and about 1200 volts with a maximum current between 7.5 amps and 10 amps, depending on the duty cycle.

Each of the voltage ranges presents unique demands on the power circuit 30 and, therefore, corresponds to a different physical configuration of the power circuit 30. More specifically, the control software 32 operates the switches 78 to physically connect and disconnect physical circuit components, such as the capacitors 88 and the bridge 90, from the portion of the power circuit 30 that is used to generate the output waveform. Thus, an output waveform generated when the power circuit 30 is operating in the first voltage range is generated by a first circuit, an output waveform generated when the power circuit 30 is operating in the second voltage range is generated by a second circuit, and an output waveform generated when the power circuit 30 is operating in the third voltage range is generated by a third circuit. Each of the different circuits comprises a different subset of the components of the power circuit 30. The voltage ranges defined above are exemplary in nature and depend on the specifications of the power source 12, the characteristics of the components of the power circuit 30 and other variables. It will be appreciated that the voltage ranges may vary from one implementation to another without departing from the spirit or scope of the invention.

To operate the power circuit 30 in the low voltage range, the control software closes switches 78B, 78C, 78D, 78E and 78F while leaving all of the remaining switches open to connect all of capacitors 88A, 88B, 88C and 88D in parallel. In this configuration, the control software 32 operates the SCRs 80, 82 to regulate the input power waveform, as explained above, and the bridge 84 rectifies the input power waveform passed by the SCRs 80, 82. The rectified input power waveform is communicated from the SCRs 80, 82 to the capacitors 88A, 88B, 88C and 88D. With the capacitors 88A, 88B, 88C and 88D connected in parallel their capacitance is cumulative, thus enhancing the filtering effect and decreasing the voltage ripple of the output.

To operate the power circuit 30 in the middle voltage range, the control software 32 closes switches 78B, 78C, 78G and 78H while leaving all of the remaining switches open to connect capacitors 88A and 88B in series with capacitors 88C and 88D. It may be desirable or necessary to open and close the switches 78 in a sequence that reduces or eliminates voltage or current spikes or other potentially harmful effects on the circuit 30. When switching from the low voltage range to the middle voltage range, for example, it may be desirable eliminate current flow in the circuit 30 before the switches 78 are opened, such as by deactivating both of the SCRs 80, 82 and opening switch 78A before opening switches 78B, 78E, 78F and 78D.

In the middle voltage range, the output voltage is approximately twice the output voltage of the low voltage range configuration for the same input power waveform. Capacitors 88C and 88D are charged during the positive portion of the input power waveform cycle and capacitors 88A and 88B are charged during the negative portion of the input power waveform cycle. Because each set of capacitors 88A/88B and 88C/88D is charged only during one-half of each input power waveform cycle, the maximum load current in the middle voltage range is approximately one-half of the maximum load current of the low voltage range configuration as illustrated in FIGS. 8 and 9.

To operate the circuit 30 in the high voltage range, the control software 32 closes switches 78I, 78C, 78G, 78H and 78J while leaving all of the remaining switches open to connect capacitors 88A and 88B in series with capacitors 88C and 88D and with capacitors 88E and 88F. To avoid or mitigate damage to the circuit 30, the control software 32 may reconfigure the circuit 30 from the middle voltage range to the high voltage range according to a safe sequence. Such a sequence may involve first deactivating both of the SCRs 80, 82 and opening switch 78A, then opening switches 78B and 78C, and then closing switches 78I and 78J.

In the high voltage range, charge from capacitors 88A-D is transferred to capacitors 88G and 88H during the negative portion of the input power cycle, and the charge from capacitors 88G and 88H is transferred to capacitors 88E and 88F during the positive portion of the input power cycle. In this configuration, the output voltage is approximately twice the output voltage of the middle voltage range configuration for the same input power waveform and the maximum output current is approximately one-half of the maximum output current of the circuit 30 when operating in the middle voltage range, as illustrated in FIGS. 8 and 9.

The control software 32 may shift the power circuit 30 between the low, middle and high voltage levels in response to changes in information submitted by the user via the user interface 28, such as where the user adjusts the output voltage using the buttons 62. The control software 32 may make the change while the controller 14 is generating an output electric waveform and communicating the waveform to the electrofishing circuit 16, although shifting between voltage ranges during operation of the electrofishing circuit 16 will result in a brief interruption in the output electric waveform as the control software 32 temporarily disables the output electric waveform while the power circuit 32 is reconfigured, as explained above.

When the user selects a particular voltage level using the voltage adjust buttons 62, the controller 14 manages operation of the circuit 30 such that the voltage of the output electric waveform matches the output voltage selected by the user. If the load becomes too great for the controller 14 to maintain the target output voltage level selected by the user, the controller 14 may automatically decrease the voltage level to accommodate the increased current demand thereby avoiding overloading the system. Such a decrease in voltage will typically be temporary and the controller 14 will increase the voltage again when the load decreases to a safe level. Such overload conditions may occur when changes in the water cause the conductivity between the anode and the cathode of the electrofishing circuit 16 to increase, and will often be temporary. When the controller 14 automatically decreases the voltage it may provide an indication to the user that an overload has occurred via one or more of the displays 44, 56, 58, 60, by causing he emergency stop button 40 to flash, or both.

The controller 14 may adjust the output voltage level within a voltage range, or may automatically shift the power circuit between the low, middle, and high voltage ranges. It may be undesirable in some situations to automatically shift the power circuit 30 between voltage ranges due to a temporary pause in the output electric waveform during the shift, as explained above.

The user can selectively prevent automatic shift between the voltage ranges via a set voltage range function. In automatic mode, the controller 14 automatically shifts when needed. In low range ceiling mode, the controller 14 will not shift from the low voltage range to the middle voltage range. If the middle range ceiling is selected, the controller 14 will not shift from the middle voltage range to the high voltage range. The controller 14 can always shift to a lower voltage, and if the controller 14 is in the high voltage range when the low range ceiling mode is selected, the controller 14 will not shift to a lower voltage range. Setting a ceiling only prevents the controller 14 from shifting to a voltage level that is greater than the selected range. The user may set the voltage range function by pressing button 46 until an indicator such as “Set Voltage Range” appears in system information display 44. Then the user may use buttons 52 to scroll through the options discussed above and select the desired voltage range option. By way of example, voltage range function options may be presented to the user via the display 44 as “LowRange Ceiling,” “MidRange Ceiling” and “Automatic.”

When the controller 14 is operating in the AC mode, switches 78K and 78L are closed while all other switches are opened. In this configuration, the input power is isolated from all of the capacitors 88 and is communicated directly to the output 24 via the SCRs 80, 82. As explained above, the controller 14 manipulates the input power waveform, including the power content and peak voltage of the input power waveform, via operation of the SCRs 80, 82.

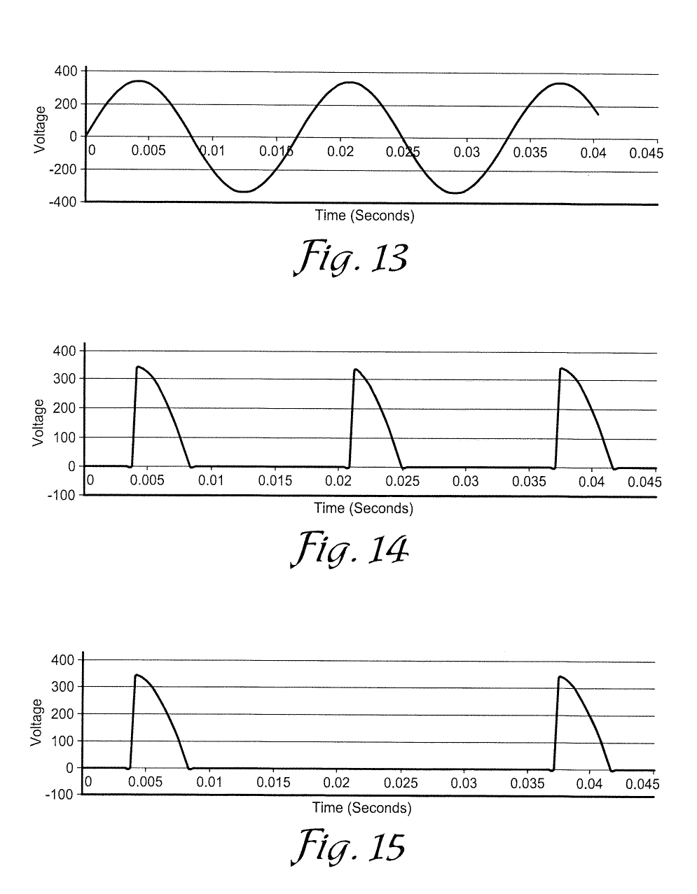

The graph of FIG. 13 illustrates the output electric waveform in one exemplary configuration of the controller 14 in AC mode, wherein the output duty cycle is set to 100% and the output voltage is set to 240 volts, which is the maximum possible output voltage if the power source is a 240 volt generator. In this configuration, each of the SCRs 80, 82 may be on 100% of the time to allow the input power waveform to pass unimpeded from the input 18 to the output 24.

If the duty cycle is set to 100% and the user reduces the output voltage, the control software 32 may reduce the output voltage by strategically activating the SCRs 80, 82 to allow only a portion of each cycle of the input power waveform to pass from the input 18 to the output 24. By way of example, FIG. 12 illustrates the resulting output electric waveform when the duty cycle is set to 100% and the voltage is set to 225 volts. FIG. 11 illustrates the resulting output electric waveform when the duty cycle is set to 100% and the voltage is set to 100 volts. In the examples illustrated in FIGS. 11 and 12, each of the SCRs 80, 82 is activated part way through each cycle of the input power waveform such that only a portion of each cycle of the waveform is passed to the output 24.

It should also be noted that the peak output voltage is reduced from about 340 volts in the graph of FIG. 12 to about 275 volts in the graph of FIG. 11. Thus, if the controller 14 is configured to manage the peak output voltage rather than the RMS value of the output voltage, the control software 32 can adjust the peak output voltage by activating the SCRs 80, 82 at points in the input power waveform cycle that correspond to the desired peak output voltage.

When the controller 14 is set by the user to operate in DC mode, the voltage selected by the user is the magnitude or peak voltage of each impulse of the square wave 94. When the controller 14 is set by the user to operate in AC mode, the voltage selected by the user is the root-mean-square value of the output electric waveform voltage. As explained above, when the controller 14 is operating in the AC mode the voltage selected by the user may alternatively be the peak voltage of each impulse of the output waveform. As used herein, the root-mean-square or “RMS” value of the input power waveform is the conventional RMS value of the waveform and represents the RMS value of the entire waveform. However, as used herein, the RMS value of the output electric waveform (in AC mode) is the root-mean-square value of each one-half cycle corresponding to a pulse. Where output electric waveforms include pulses separated by pauses (i.e., periods of time in which the output voltage is zero) equal to one or more one-half cycles, the pauses are excluded from RMS calculations. Therefore, the RMS value of the output electric waveforms illustrated in FIGS. 14 and 15 are equal because the pulses are equal and the pauses between pulses are not calculated as part of the RMS of the output electric waveform.

In another exemplary configuration of the controller 14 operating in AC mode, the SCRs 80, 82 are operated to generate a one-half cycle direct current waveform, such as the waveforms illustrated in FIGS. 14 and 15. FIG. 14 illustrates the resulting output electric waveform when the user sets the pulses per second to 60, the duty cycle to 50%, and the voltage to 170. FIG. 15 illustrates the resulting output waveform when the user sets the pulses per second to 30, the duty cycle to 25% and the voltage to 170. FIG. 16 is a chart presenting various settings that yield a positive one-half cycle the controller 14 is set to operate in AC mode.

In the examples illustrated in FIGS. 14 and 15, the voltage set by the user determines the shape of each pulse. In both examples, the voltage is set to 170 volts, which is the RMS value of each pulse calculated only over one-half of a cycle of the waveform. The pulses per second set by the user determines how frequently a new pulse is generated. In the graph of FIG. 14 the pulses per second is set to 60, so the pulses are generated at a rate of 60 per second, or one every 0.0167 seconds. In the graph of FIG. 15 the pulses per second is set to 30, so the pulses are generated at a rate of 30 per second, or one every 0.0333 seconds. The duty cycle set by the user corresponds to the percentage of time each pulse is “on” or “active” relative to the entire length of each pulse. In the graph of FIG. 14 the duty cycle is set to 50%, so only every other half cycle is included in the pulse. In the graph of FIG. 15 the duty cycle is set to 25%, so only one of four half cycle is included in each pulse. In other words, each pulse of the waveform illustrated in FIG. 15 includes one half cycle “on” followed by three half cycles “off.”

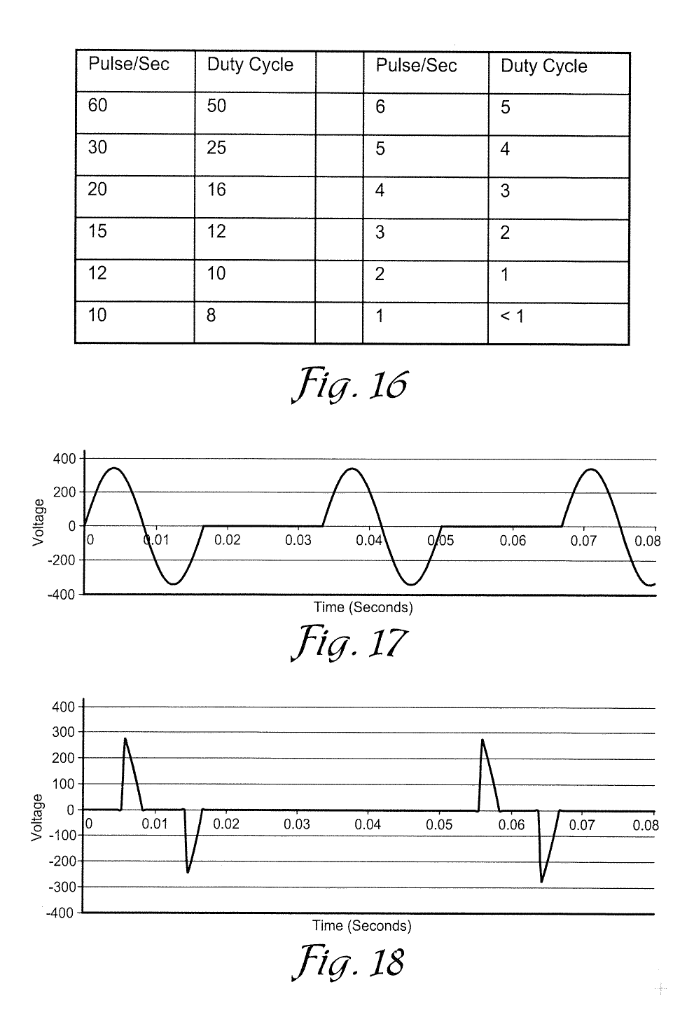

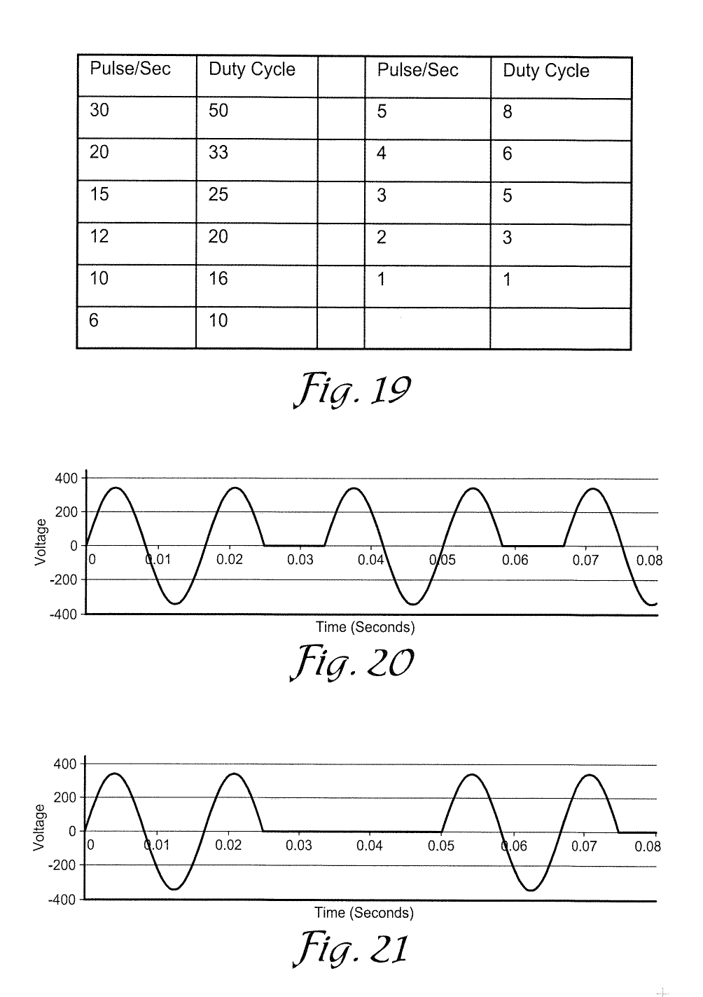

In another exemplary configuration of the controller 14 in AC mode, the SCRs 80, 82 are operated to generate an output electric waveform that is characterized by a series of full cycles separated by “pauses” or periods of zero output power. FIG. 17 illustrates an output waveform pattern characterized by one unimpeded complete cycle of the input power waveform followed by a pause corresponding to one full cycle of the input waveform. This waveform is generated when the user sets the pulses per second to 30, the duty cycle to 50, and the voltage to 240. If the output voltage is reduced to 100, the pulses per second is reduced to 20, and the duty cycle is reduced to 33, an output power waveform similar to that illustrated in FIG. 18 results. It should be noted that in these two examples, the duty cycle corresponds to the number of complete cycles of “on” time versus the number of complete cycles of “off” time. FIG. 19 is a chart presenting various settings that result in a single-cycle output power waveform when the controller 14 is set to operate in AC mode.

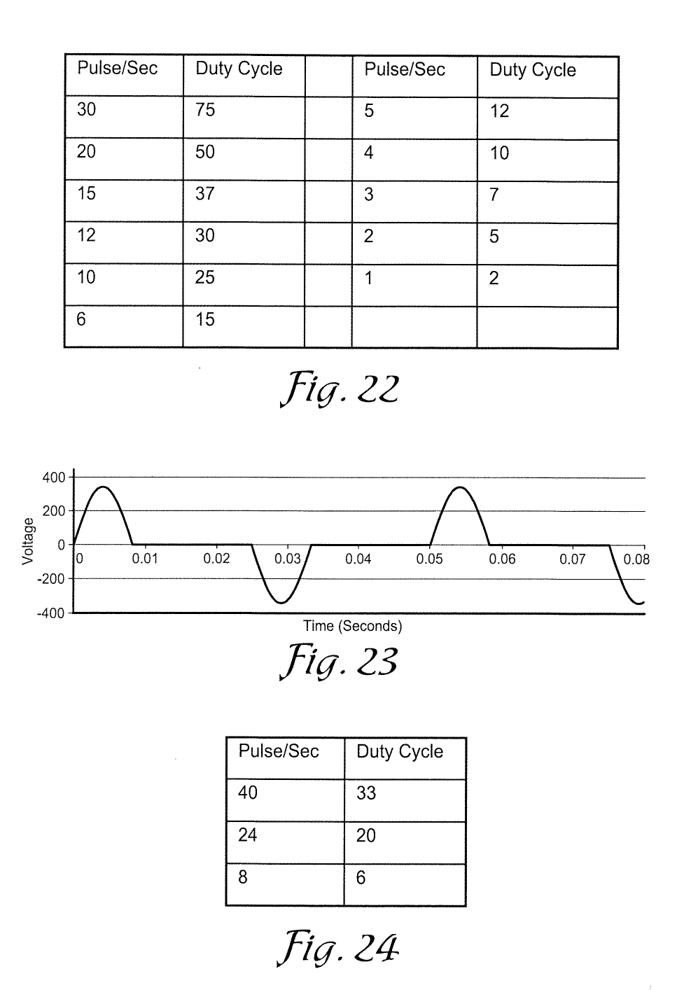

In another exemplary configuration of the controller 14 in AC mode, the SCRs 80, 82 are operated to generate an output electric waveform that is characterized by a series of one and one-half cycles separated by pauses. FIG. 20 illustrates an output electric waveform pattern characterized by a series of one and one-half unimpeded cycles of the input power waveform, each followed by a pause equal to one-half of a cycle of the input waveform. The output waveform illustrated in FIG. 20 is generated when the user sets the pulses per second to 30, the duty cycle to 75, and the voltage to 240. FIG. 21 illustrates an output electric waveform pattern characterized by a series of one and one-half unimpeded cycles of the input power waveform each followed by a pause equal to one and one-half cycles of the input waveform. The output waveform illustrated in FIG. 21 is generated when the user sets the pulses per second to 20, the duty cycle to 50, and the voltage to 240. FIG. 22 is a chart presenting various settings that result in a one and one-half cycle output power waveform when the controller 14 is operating in AC mode.

In another exemplary configuration of the controller 14 in AC mode, the control software 32 operates the SCRs 80, 82 to generate an output electric waveform with pulses that alternate in polarity. FIG. 23 illustrates an output waveform pattern characterized by a series of alternating pulses, each pulse being equal to one-half of an input cycle and separated by a pause equal to one cycle of the input waveform. The electric waveform illustrated in FIG. 23 is generated when the user sets the pulses per second to 40, the duty cycle to 33, and the voltage to 240. FIG. 24 is a chart presenting various settings that result in electric waveforms characterized by a series of one-half cycle, alternating polarity pulses.

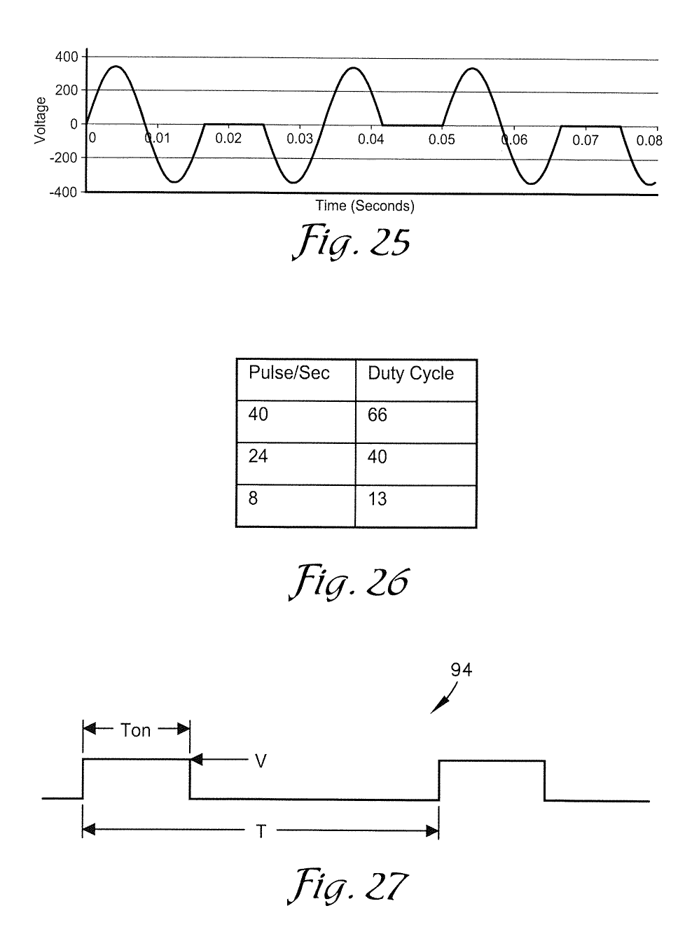

In another exemplary configuration of the controller 14 in AC mode, the control software 32 operates the SCRs 80, 82 to generate an output waveform characterized by a series of single cycles alternating in polarity. FIG. 25 illustrates an output electric waveform pattern characterized by a series of single cycles alternating in polarity, each cycle being separated by a pause equal to one-half of a cycle of the input power waveform. The output waveform illustrated in FIG. 25 is generated when the user sets the pulses per second to 40, the duty cycle to 66, and the voltage to 240. FIG. 26 is a chart presenting various settings that result in single cycle, alternating polarity output power waveform from the alternating current portion of the power circuit.

The above-described waveforms are defined in part by the voltage set by a user via the user interface 28 which is the target RMS value of the output waveform. As explained above, though, the voltage submitted by the user may alternatively be the target peak voltage of the output waveform rather than the RMS value. In the latter scenario, the control software 32 controls the SCRs 80, 82 to pass the input power waveform at a point in each cycle when the voltage of the input power waveform is approximately equal to the target peak output voltage selected by the user.

The control system 10 is particularly suited for use in a boat or similar vessel. In use, the user positions the power source 12 and controller 14 in secure locations and, if necessary, positions the external switch 22. If the external switch 22 is a foot switch, for example, the user may position the foot switch on the floor of the boat where it can be conveniently operated. The electrofishing circuit 16 is positioned, such as by placing one or more booms to extend over an edge of the boat and position one or more anodes in the water explained above. The protective covers 74 are removed from the connectors 68, 15 70, 72 and the plugs are attached to the connectors 68, 70, 72 to connect the power source 12, the electrofishing circuit 16 and the switch 22 to the controller 14. The power source 12 is activated (if necessary), and the main power breaker is closed by moving switch 42 to an “on” position. The user then selects the AC mode or DC mode by selecting button 66 or 64, respectively. The user then sets 20 the desired pulse frequency by selecting the pulses button 48 and adjusts the frequency using the adjust buttons 52. The user sets the desired duty cycle by selecting the duty cycle button 50 and adjusting the duty cycle using the adjust buttons 52.

The user may preset the voltage using the voltage adjust buttons 62, and may reset the fishing time if desired by selecting the time reset button 54. The user may need to reset the emergency stop button 40 by, for example, rotating it a portion of a turn to release it to return to its normal operating position. When the user presses the reset button 67, the system is live and depressing the switch 22 activates the system and sends the output electric waveform from the controller 14 to the electrofishing circuit 16. One or more visual indicators on the user interface may signal to the user that the system 10 is live. An exemplary visual indicator may include, for example, illuminating the emergency stop button 40.

When the system 10 is live, the user selectively applies electric current to the water via the electrofishing circuit 16 by depressing the switch 22. During operation, the power, voltage and current applied to the water are indicated in the displays 58, 60, and 56, respectively. The user may adjust the voltage during operation by selecting the voltage adjust buttons 62.

When the controller 14 is powered down, the system information button 46 may be selected to cause the controller 14 is recall certain settings when the controller 14 was last operated. Such settings may include pulses per second, duty cycle, fishing time, output voltage, generator voltage and frequency, emergency stop button dimmer level, controller cumulative hours, and display and power board revisions.

The controller 14 may indicate whether the external switch 22 is functioning correctly before it is used to activate the electrofishing circuit 16. By way of example, if the user activates the switch 22 when the controller 14 is powered on but before it is live (i.e., before the reset button 67 is pressed), the controller may provide a visual indicator in one of the displays 44, 56, 58 or 60 indicating that the controller 14 received a valid control signal from the switch 22. This indicates to the user that once the system 10 is live, activating the switch will cause the controller 14 to communicate an output electric waveform to the electrofishing circuit 16.

Although the invention has been described with reference to the exemplary embodiments illustrated in the attached drawings, it is noted that equivalents may be employed and substitutions made herein without departing from the scope of the invention as recited in the claims. For example, while the power circuit 30 illustrated and described herein includes a first pair of capacitors 88A and 88B that operate in parallel and a second pair of capacitors 88C and 88D that also operate in parallel, each pair of capacitors may be replaced by a single capacitor or by a group of three, four or more capacitors.

Having thus described various embodiments of the invention, what is claimed as new and desired to be protected by Letters Patent includes the following:

1. An electrofishing controller comprising:
a power input;
an output;
a user interface for receiving configuration information from a user; and
control circuitry for receiving electric power from the power input, generating an electric waveform with characteristics defined by the configuration information, and communicating the electric waveform to the output, the control circuitry being configured to automatically change the characteristics of the electric waveform in response to changes in an electric load on the output, and to automatically restore the electric waveform to the characteristics defined by the configuration information.

2. The electrofishing controller of claim 1, the control circuitry being configured to change the characteristics of the electric waveform in response to receiving new configuration information from the user, including changing physical connections between circuit components such that the control circuitry uses a first circuit to generate a first electric waveform and uses a second circuit to generate a second electric waveform in response to receiving the new configuration information from the user.

3. The electrofishing controller of claim 1, the changes in the electric load including changes in an amount of current drawn from the controller by the load.

4. The electrofishing controller of claim 3, further comprising a current sensor for determining a level of electric current drawn from the controller by the load.

5. The electrofishing controller of claim 1, the configuration information including pulse frequency, voltage level and duty cycle.

6. The electrofishing controller of claim 5, the control circuitry configured to automatically decrease the electric waveform voltage in response to an increase in current drawn from the output, and to automatically restore the electric waveform to the voltage received from the user as part of the configuration information.

7. The electrofishing controller of claim 5, the voltage level being the peak voltage of the electric waveform.

8. The electrofishing controller of claim 5, the voltage level being a root-mean-square value of the electric waveform.

9. The electrofishing controller of claim 1, further comprising a switch input, the control circuitry being configured to receive a control signal from the switch input for activating delivery of the electric waveform to the output.

10. The electrofishing controller of claim 9, the user interface providing a visual indication that the control circuitry has received a valid control signal via the switch input.

11. The electrofishing controller of claim 1, the user interface configured to receive mode information from the user, the mode information indicating whether the control circuitry is configured to operate in alternating current mode or in direct current mode.

12. An electrofishing controller comprising:
a power input;
an output;
a user interface for receiving first configuration information from a user, the first configuration information including pulse frequency, duty cycle, and voltage level; and
control circuitry for receiving electric power from the power input, generating an electric waveform with characteristics defined by the first configuration information, and communicating the electric waveform to the output;
the control circuitry being configured to automatically decrease the voltage level of the electric waveform in response to an increased current drawn from the output and to automatically restore the voltage level of the electric waveform to the voltage level received from the user when the current decreases,
the control circuitry being configured to change the characteristics of the electric waveform in response to receiving second configuration information from the user by changing physical connections between circuit components such that a first circuit generates a first electric waveform according to the first configuration information and a second circuit generates a second electric waveform according to the second configuration information.

13. The electrofishing circuit of claim 12, the first circuit generating an electric waveform with a first voltage level and a first maximum current, the second circuit generating an electric waveform with a second voltage level and a second maximum current, the first voltage level being less than the second voltage level and the first maximum current being greater than the second maximum current.

14. The electrofishing controller of claim 13, the control circuitry including a first capacitor and a second capacitor, the first circuit including the first capacitor connected in parallel with the second capacitor and the second circuit including the first capacitor connected in series with the second capacitor.

15. The electrofishing controller of claim 12, the control circuitry including a pair of silicon controlled rectifiers for regulating electric power communicated from the power input to the control circuitry, the control circuitry configured to phase shift operation of the silicon controlled rectifiers to selectively pass a portion of an input power waveform received from the power input.

16. The electrofishing controller of claim 12, the voltage level being the peak voltage of the electric waveform.

17. The electrofishing controller of claim 12, the voltage level being a root-mean-square value of the electric waveform.

18. The electrofishing controller of claim 12, further comprising a switch input, the control circuitry being configured to receive a control signal from the switch input for activating delivery of the electric waveform to the output.

19. The electrofishing controller of claim 18, the user interface providing a visual indication that control circuitry has received a valid control signal via the switch input.

20. A method of generating an electric waveform for electrofishing, the method comprising:
receiving electric power;
receiving configuration information from a user;
generating the electric waveform using the electric power and according to the configuration information received from the user;
communicating the electric waveform to an electrofishing circuit; and
automatically changing characteristics of the electric waveform in response to changes in an electric load, and automatically restoring the electric waveform to characteristics defined by the configuration information received from the user.
